(19) United States
(12) Patent Application Publication
(10) Pub. No.: US 2006/0014887 A1
(43) Pub. Date: Jan. 19, 2006

(54) Method of hydrolyzing a dispersion of ionic fluoropolymer

(75) Inventors: Steven J. Hamrock, Stillwater, MN (US); Klaus Hintzer, Kastl (DE); Kai H. Lochhaas, Neuoetting (DE); Tanja Zeif, Fridolfing (DE); Harold T. Freemyer, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/894,098

(22) Filed: Jul. 19, 2004

(51) Int. Cl. C08L 27/12

(52) U.S. Cl. 524/544; 524/800

(57) ABSTRACT

Aqueous dispersions of fluoropolymers having fluorosulfonyl groups are hydrolyzed to form dispersions of ionic fluoropolymers by addition of base.

### BACKGROUND

Ionic fluoropolymers (e.g., fluorinated ionomers or fluorinated polyelectrolytes) are polymers that have covalently bound ionic groups such as, for example, —SO₃⁻. In solid form, the ionic groups are typically present as salts with cationic species (e.g., with Na⁺ or Zn²⁺), while in aqueous solutions the ionic groups exist as the free —SO₃⁻ form. Ionic fluoropolymers are used to manufacture membranes that are used in fuel cells. Such membranes are typically formed by casting a dispersion of ionic fluoropolymer in an aqueous medium on a substrate and subsequently removing the aqueous medium.

The process for making a dispersion of ionic fluoropolymer typically involves emulsion polymerization of fluorinated monomers that include one or more monomers with a hydrolyzable group such as —SO₂F to form a substantially non-ionic fluoropolymer dispersion. The resultant dispersion is then coagulated, for example, by freeze coagulation, high shear coagulation, or salt coagulation.

Typically, anionic impurities (e.g., surfactant) and residual monomer from the polymerization process that are present in the coagulated polymer are reduced in quantity by purification processes such as, for example, rinsing, extracting, and steam distillation.

After coagulation and purification, the hydrolyzable groups on the coagulated polymer are typically hydrolyzed.

In one method, the coagulated polymer is formed into a membrane and then hydrolyzed. However, in this method it may be difficult to achieve a high degree of hydrolysis without damaging the membrane, and suitable methods for purifying the hydrolyzed membrane are limited.

According to another method, in a process that is generally carried out using specialized equipment, the partially purified coagulated polymer is redispersed and hydrolyzed in a single step using heat and aqueous lithium hydroxide under high shear conditions to give an aqueous dispersion of fluorinated ionomer. However, in this process the coagulated polymer is typically used as an extremely fine powder, which may present special handling precautions, and may be difficult to physically handle without considerable yield losses.

### SUMMARY

In one aspect, the present invention provides a method of making a dispersion of ionic fluoropolymer comprising:
providing a dispersion of a hydrolyzable fluoropolymer in a first aqueous medium, the hydrolyzable fluoropolymer having a plurality of pendant hydrolyzable groups represented by the formula —R¹SO₂X, wherein R¹ is a perfluoroalkylene group having from 1 to 15 carbon atoms, or a perfluoroalkyleneoxy or perfluoropoly (alkyleneoxy) group having from 1 to 15 carbon atoms and from 1 to 4 oxygen atoms, and X represents F, Cl, or Br;
combining a base with the hydrolyzable dispersion to form a reaction mixture; and
maintaining the reaction mixture at sufficient temperature and for sufficient time to cause at least a majority of the hydrolyzable groups to hydrolyze and form a dispersion of ionic fluoropolymer in a second aqueous medium, wherein the ionic fluoropolymer has a sulfonate equivalent weight in the range of from at least 600 grams up to and including 1200 grams.

The method of the present invention reduces the number of steps necessary to hydrolyze the dispersion of a hydrolyzable fluoropolymer resulting from emulsion polymerization and eliminates the need for specialized equipment as discussed above, thereby reducing time and expense of the hydrolysis process.

As used herein:
the term “fluoropolymer” refers to an organic polymer having a fluorine content of at least 30 percent by weight based on the total weight of the polymer;
the term “pendant group” as applied to polymers does not include end-groups;
the term “sulfonate equivalent weight” refers to that weight of polymer containing one mole of sulfonate groups (i.e., —SO₃⁻).

All numerical ranges set forth herein are inclusive of their endpoints unless otherwise specified.

### DETAILED DESCRIPTION

Useful fluoropolymers having a plurality of hydrolyzable groups include polymers that are preparable from one or monomers comprising at least one monomer represented by Formula I:
F₂C═CF—R¹—SO₂X (I)
wherein:
R¹ is a perfluoroalkylene group (e.g., branched or unbranched perfluoroalkylene) having from 1 to 15 carbon atoms, or a perfluoroalkyleneoxy or perfluoropoly(alkyleneoxy) group (e.g., branched or unbranched) having from 1 to 15 carbon atoms and from 1 to 4 oxygen atoms; and
X represents F, Cl, or Br; typically fluorine or chlorine, more typically fluorine.

For example, R¹ may be —(CF₂)ₐ— or —O(CF₂)ₐ—, wherein a is an integer in the range of from 1 to 15 (e.g., 1, 2, 3, 4, 5, 6, 7, 8, 9, 10, 11, 12, 13, 14, or 15); —(CF₂CF(CF₃))_{b}—, —(CF(CF₃)CF₂)_{b}—, —(OCF₂CF₂CF₂)_{b}—, —(OCF₂CF(CF₃))_{b}—, or —(OCF(CF₃)CF₂)_{b}—, wherein b is an integer in the range of from 1 to 5 (e.g., 1, 2, 3, 4, or 5); —(CF₂CF(CF₃))_{c}CF₂—, —(OCF₂CF(CF₃))_{c}OCF₂CF₂—, or —(OCF(CF₃)CF₂)_{c}OCF₂CF₂—, wherein c is an integer in the range of from 1 to 4 (e.g., 1, 2, 3, or 4); —(OCF₂CF₂CF₂CF₂)_{d}—, —(OCF₂CF(CF₂CF₃))_{d}—, —(OCF(CF₂CF₃)CF₂—)_{d}, —(OCF₂CF(CF₂CF₃))_{d}OCF₂CF₂—, —(OCF(CF₂CF₃)CF₂)_{d}OCF₂CF₂—, wherein d is an integer in the range of from 1 to 3 (e.g., 1, 2, or 3); or (—O—CF₂CF₂—)ₑ, wherein e is an integer in the range of from 1 to 7 (e.g., 1, 2, 3, 4, 5, 6, or 7). In one embodiment, R¹ is typically —O—CF₂CF₂CF₂CF₂— or —OCF₂CF(CF₃)OCF₂CF₂—.

Such monomers can be prepared according any suitable means including, for example, methods disclosed in U.S. Pat. No. 6,624,328 B1 (Guerra) and U.S. Pat. No. 6,593,019 (Armand et al.), the disclosures of which are incorporated herein by reference.

Any amount of monomer according to Formula I may be included in the fluoropolymer, for example, in an amount of from about at least 5 or 15 mole percent up to and including about 25, 30 or even 50 mole percent. For use in fuel cells, the amount of monomer according to Formula I is typically selected such that after hydrolysis, the sulfonate equivalent weight of the resultant ionic fluoropolymers is generally in the range of from at least 600, 700, or 800 g up to and including 1000, 1100, or even 1200 g.

Typically, although not a requirement, the fluoropolymer is prepared by copolymerizing at least one monomer represented by Formula I with at least one ethylenically unsaturated co-monomer.

Useful ethylenically unsaturated co-monomers include perfluorinated co-monomers represented by Formula II:
F₂C═CFR² (II)
wherein R² represents F or a branched or unbranched perfluoroalkyl, perfluoroalkoxy or perfluoropoly (alkyleneoxy) group comprising 1 to 5 carbon atoms and 0 to 2 oxygen atoms. Examples include tetrafluoroethylene, hexafluoropropylene, CF₃OCF₂CF₂CF₂OCF═CF₂, CF₃OCF═CF₂, CF₃CF₂CF₂OCF═CF₂, perfluoro-1,3-dioxoles such as those described in U.S. Pat. No. 4,558,142 (Squire), fluorinated diolefins (e.g., perfluorodiallyl ether or perfluoro-1,3-butadiene), and combinations thereof.

Useful ethylenically unsaturated co-monomers also include perfluorinated vinyl ether represented by Formula III:
F₂C═CFO(R_{f}O)ₙ(R_{f′}O)ₘR_{f″} (III)
wherein R_{f} and R_{f′} are different linear or branched perfluoroalkylene groups having 2 to 6 carbon atoms, m and n are independently integers in the range of from 0 to 10 (e.g., 0, 1, 2, 3, 4, 5, 6, 7, 8, 9, or 10), wherein the sum of n and m is at least 1, and R_{f″} is a perfluoroalkyl group having 1 to 6 carbon atoms.

Examples of perfluorinated vinyl ethers of formula (III) include compounds of the formula (IV):
F₂C═CFO(CF₂CF₂CFZO)ₚR_{f″} (IV)
wherein R_{f″} is as previously defined, p is an integer in the range of from 1 to 5 (e.g., 1, 2, 3, 4, or 5), and Z is F or CF₃. Examples of compounds of formula (IV) include those in which R_{f″} is C₃F₇, p=1, Z=F or CF₃ and CF₃OCF(CF₃)CF₂CF₂OCF═CF₂. Further useful fluorinated vinyl ethers included in formula (III) correspond to the formula (V):
F₂C═CFO(CF₂CFXO)ₚR_{f′″} (V)
wherein p is as previously defined, X is F or CF₃, and R_{f′″} is a perfluoroalkyl group having from 1 to 5 carbon atoms. Examples of monomers of formula V include those wherein X is CF₃ and R_{f′″} is perfluorinated n-propyl, and p is 1 or p is 2.

Additional perfluorinated vinyl ether monomers useful in the invention include compounds of the formula
F₂C═CFO[(CF₂CF(CF₃)O)ᵢ(CF₂CF₂CF₂O)ⱼ(CF₂)ₖ]CₓF₂ₓ₊₁ (VI)
wherein i and j are independently integers in the range of from 0 to 10 (e.g., 1, 2, 3, 4, 5, 6, 7, 8, 9, or 10), k is an integer in the range of from 0 to 3 (e.g., 0, 1, 2, or 3), and x is an integer in the range of from 1 to 5 (e.g., 1, 2, 3, 4, or 5). Examples include compounds wherein j=1, i=1, k=0, and x=1.

Still further examples of perfluorinated vinyl ethers include ethers corresponding to formula (VII):
F₂C═CFOCF₂CF(CF₃)O(CF₂O)_{q}CF₃ (VII)
wherein q is an integer in the range of from 0 to 3 (e.g., 0, 1, 2, or 3).

In addition, non-perfluorinated ethylenically unsaturated co-monomers may be used, typically in combination with at least one of the perfluorinated co-monomers listed above. Examples include ethylene, propylene, butylene, trifluoroethylene, 1-hydropentafluoropropene, 2-hydropentafluoropropene, vinyl fluoride, and vinylidene difluoride, and combinations thereof. If used, the amount of these co-monomers in the final copolymer is typically less than 40 mole percent, and more typically less than 20 mole percent.

Additional non-perfluorinated co-monomers that may be used include those represent by Formula VIII:
F₂C═CF[OCF₂CF(CF₃)]_{f}O(CF₂)_{g}C(═O)OCH₃ (VIII)
wherein f is an integer in the range of from 0 to 3 (e.g., 0, 1, 2, or 3), and g is an integer in the range of from 0 to 6 (e.g., 0, 1, 2, 3, 4, 5, or 6).

Additional neutral monomers include cure site monomers (CSM's) having groups containing Br, Cl, I, or —CN. Useful CSM's include those having the formula CF₂═CY-Q where Y is typically F but may also be CF₃, and where Q is a group which includes Br, Cl, I, or CN. Typically, Q is highly fluorinated or perfluorinated group, for example, having the formula —R¹-Z, where R¹ is as described above and Z is Br, Cl, I, or CN. Further details concerning useful cure site monomers and methods for curing them may be found in U.S. patent application Ser. No. 10/712,589 (Yandrasits et al.) and Ser. No. 10/712,590 (Yandrasits et al.), the disclosures of which are incorporated herein by reference.

The foregoing monomers, generally in combination with an effective amount of a free radical initiator (e.g., ammonium persulfate or a redox system such as ammonium persulfate/disulfite and potassium permanganate, and peroxides such as, for example, substituted dibenzoyl peroxides, cumene hydroperoxide, and bisperfluoropropionyl peroxide). Suitable aqueous emulsion polymerization techniques are described, for example, in U.S. Pat. No. 4,138,373 (Ukihashi et al.) and U.S. Pat. No. 4,320,205 (Asawa et al.). To ensure a homogeneous incorporation and high utilization of liquid monomers, so-called pre-emulsification techniques may be used, whereby the liquid co-monomers are pre-emulsified in water with perfluorinated emulsifiers (e.g. salts of perfluorooctanoates (i.e., APFO)) prior to the polymerization with other gaseous monomers. Such procedures and techniques are described in U.S. Pat. No. 5,608,022 (Nakayama et al.); U.S. Pat. No. 5,595,676 (Barnes et al.); and U.S. Pat. No. 6,602,968 (Bekiarian et al.).

The content of fluoropolymer having a plurality of pendant hydrolyzable groups represented by the formula —R₁SO₂X, hereinafter referred to as the “hydrolyzable fluoropolymer”, in dispersions according to the present invention may be any amount greater than zero (e.g., at least 1, 5, 10, 20, 30, or 40 percent by weight or more), but typically is in the range of from 15 to 45 percent by weight.

The hydrolyzable fluoropolymer may have a fluorine content of at least 30, 40, 50, 60 or even at least 70 percent by weight based on the total weight of the polymer. In one embodiment, the fluoropolymer may be perfluorinated.

Residual neutral monomer(s) may be removed, for example, by water steam distillation (i.e., stripping or encircling) either before or after hydrolysis.

In order to hydrolyze at least a majority (e.g., at least 50, 60, 70, 80, 90, or 95 percent or even more) of the hydrolyzable groups of the hydrolyzable fluoropolymer, a base is added to the dispersion, which is then maintained at sufficient temperature and for sufficient time that the desired degree of hydrolysis occurs.

Any base may be used, but preferably the base is at least strong enough to adjust the pH of the aqueous phase of the dispersion to at least 8, more typically at least 10 or even 12. Typically, the base is chosen such that any cationic and anionic species introduced by the base may be easily removed at a later time (e.g., by volatilization or ion exchange).

The amount of base to be added to the dispersion of hydrolyzable polymer is typically determined by the composition of the hydrolyzable polymer, the desired degree of hydrolysis, and the desired rate of hydrolysis. Typically, the amount of base ranges from about 0.5 equivalents of base up to about 10 equivalents of base per equivalent of hydrolyzable groups in the hydrolyzable polymer, although lesser or greater amounts of base may also be used. Buffer may also be added to the dispersion, for example, to control the rate and/or selectivity of the hydrolysis process.

Useful bases include, for example, alkali metal hydroxides (e.g., lithium hydroxide, sodium hydroxide or potassium hydroxide), ammonium hydroxide, quaternary alkyl ammonium hydroxides, alkaline earth hydroxides (e.g., magnesium hydroxide or calcium hydroxide), and hydroxides of Group III metals (e.g., hydroxides of Co, Ni, Mn, Fe, Al, Cr, or Zn). Additional inorganic basic salts like alkali metal carbonates and ammonium carbonate may be used, especially in instances wherein the hydrolyzable fluoropolymer contains C—H bonds (e.g., in the polymer backbone). Typically, alkali metal hydroxides or NH₄OH are used, more typically LiOH or NH₄OH.

Once the base is combined with the dispersion of hydrolyzable fluoropolymer, the mixture is maintained, typically with stirring, at sufficient temperature and for sufficient time as to cause a majority of the hydrolyzable groups to hydrolyze and form a dispersion of ionic fluoropolymer. The hydrolysis may be carried out at, or even below, room temperature, but is typically performed with heating at a temperature in the range of from about 60 degrees up to and including about 100 degrees. At these temperatures, it is typically possible to achieve a high degree of hydrolysis in as little as one hour using a base such as, for example, lithium hydroxide. However, the hydrolysis may be done at elevated pressure and/or higher temperature.

After preparation, the dispersion of ionic fluoropolymer may be further purified to remove residual monomer, solvent, anionic species (e.g., surfactant or emulsifiers used in the emulsion polymerization), and cationic species (e.g., from the basic hydrolysis).

Useful methods for removing cationic and anionic impurities from the dispersion include, for example, the use of cation and/or anion-exchange resins (e.g., either in loose form or as a packed column) as described in concurrently filed U.S. Pat. Appl. entitled “METHOD OF PURIFYING A DISPERSION OF IONIC FLUOROPOLYMER” and bearing Attorney Case No. 59588US002, the disclosure of which is hereby incorporated by reference.

Anionic exchange resins are available commercially. Examples of commercially available anion-exchange resins include resins having the trade designation “AMBERLITE IRA-402”, “AMBERLYST A260H”, or “AMBERJET 4200” available from Rohm & Haas Company, Philadelphia, Pa.; resins having the trade designation “PUROLITE A845” available from The Purolite Company, Bala Cynwyd, Pa.; resins having the trade designation “LEWATIT MP-500” available from Sybron Chemicals, Birmingham, N.J.; and resins having the trade designations “DOWEX 1×2” and “DOWEX 1×8” available from Dow Chemical, Midland, Mich. Anion-exchange resins such as those described above are commonly supplied commercially as salts with either hydroxide or some other anion. If the anion-exchange resin is not in the hydroxide form it should be at least partially converted, typically fully converted, to the hydroxide salt form. This is typically done by treating the anion-exchange resin with an aqueous ammonia or sodium hydroxide solution.

Typical cationic impurities resulting from the abovementioned polymerization and hydrolysis steps include, for example, one or more of, alkali metal cation(s) (e.g., Li⁺, Na⁺, K⁺), ammonium, quaternary alkyl ammonium, alkaline earth cations (e.g., Mg²⁺, Ca²⁺), and Group III metal cations. Useful cation-exchange resins include polymers (typically cross-linked) that have a plurality of pendant anionic or acidic groups such as, for example, polysulfonates or polysulfonic acids, polycarboxylates or polycarboxylic acids. Sulfonic acid cation-exchange resins contemplated for use in the practice of the invention include, for example, sulfonated styrene-divinylbenzene copolymers, sulfonated crosslinked styrene polymers, phenol-formaldehyde-sulfonic acid resins, and benzene-formaldehyde-sulfonic acid resins. Carboxylic acid cation-exchange resin is an organic acid, cation-exchange resin, such as carboxylic acid cation-exchange resin.

Cation-exchange resins are available commercially. Examples of suitable commercially available cation-exchange resins include: resins having the trade designations “AMBERJET 1200”, “AMBERLITE IR-120”, “AMBERLITE IR-122”, or “AMBERLITE 132 E” available from Rohm and Haas Company, Philadelphia. Pa.; resins having the trade designations “DIAION SK 1B” and “DIAION SK 110” available from Mitsubishi Chemical, Tokyo, Japan; resins having the trade designations “DOWEX HCR-W2”, “DOWEX HCR-S”, and “DOWEX 650C”, available from Dow Chemical Company, Midland, Mich.; resins having the trade designations “IONAC C-249”, “IONAC C-253”, “IONAC C-266”, and “IONAC C-267”; and resins having the trade designations “LEWATIT S 100”, “LEWATIT S 100H” (acid form), “LEWATIT S 110”, “LEWATIT S110H” (acid form), “LEWATIT S 1468”, “LEWATIT MONOPLUS SP 112”, “LEWATIT MONOPLUS SP 112” (acid form), “LEWATIT S 2568”, and “LEWATIT S 2568H” (acid form), all available from Sybron Chemicals, Inc.; and resins having the trade designations “PUROLITE C-100”, “PUROLITE C-100 E”, “PUROLITE C-100×10”, and “PUROLITE C-120 E” available from The Purolite Company. It is expected that other products of the same type would be equally satisfactory.

Cation-exchange resins such as those described above are commonly supplied commercially in either their acid or their sodium form. If the cation-exchange resin is not in the acid form (i.e., protonated form) it should be at least partially converted, typically fully converted, to the acid form in order to avoid the generally undesired introduction of other cations into the dispersion. This conversion to the acid form may be accomplished by means well known in the art, for example by treatment with any adequately strong acid. Ion exchange resins (anion-exchange resins and/or cation-exchange resins) may be used in a packed column configuration where the dispersion of ionic fluoropolymer is passed through the column. In another method, loose ion exchange resin particles may be added to dispersion of ionic fluoropolymer with mild agitation, and later removed by filtration. Ways to agitate include shaking a vessel containing the mixture, stirring the mixture in a vessel with a stirrer, rotating the vessel, and bubbling a gas (e.g., nitrogen or air) through the mixture. A further method to cause agitation of the mixture of ion exchange resin and dispersion of ionic fluoropolymer is fluidizing the ion exchange resin. Fluidization maybe caused by flowing the dispersion through the ion exchange resin in a vessel whereby the flow of the dispersion causes the exchange resin to swirl. The conditions of agitation are generally selected such that on the one hand, the anion-exchange resin is fully contacted with the dispersion (i.e., the anion-exchange resin is completely immersed in the dispersion), and yet the agitation conditions will be sufficiently mild so as to avoid damaging the ion exchange resin.

Optionally, the concentration of the dispersion of ionic fluoropolymer (e.g., before and/or after further purification) may be increased (e.g., by removal of water and/or organic solvent by evaporation or azeotropic distillation) and/or reduced (e.g., by addition of water and/or organic solvent). Typically, if the dispersion of ionic fluoropolymer is to be used to form a membrane, the concentration of ionic fluoropolymer is increased to a high level (e.g., at least 30 or 40 percent by weight) and a water-miscible organic solvent is added to facilitate film formation. Examples of water-miscible solvents include, lower alcohols (e.g., methanol, ethanol, isopropanol, n-propanol), polyols (e.g., ethylene glycol, propylene glycol, glycerol), ethers (e.g., tetrahydrofuran and dioxane), ether acetates, acetonitrile, acetone, and combinations thereof.

The hydrolyzable fluoropolymer dispersion may be used to form a polymer electrolyte membrane by any suitable method including, for example, bar coating, spray coating, slit coating, brush coating, casting, molding, and extrusion. After forming, the membrane may be annealed, typically at a temperature of 120 degrees Celsius (° C.) or higher, more typically 130° C. or higher, most typically 150° C. or higher. Typically, the membrane has a thickness of less than 90 microns, more typically less than 60 microns, and more typically less than 30 microns.

The hydrolyzable fluoropolymer dispersion may be combined with catalyst and carbon particles to form a catalyst ink that may be used in the fabrication of membrane electrode assemblies (MEA's) for use in fuel cells. Specific details concerning the preparation of catalyst inks and their use in fabrication of membrane assemblies may be found, for example, in U.S. Pat. Publ. No. 2004/0107869 A1 (Velamakanni et al.), the disclosure of which is incorporated herein by reference.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

Test Methods

Melt flow index (MFI) was measured according to ISO 12086 (December 1985), using a standardized extrusion die of 2.1 mm diameter and 8 mm length at 265° C. and a 5 kg load.

Particle size was measured by dynamic light scattering according to ISO/DIN 13321 (October 2003) using an apparatus available from Malvern Instruments under the trade designation “ZETASIZER 1000 HAS”. Prior to the measurements the latex was diluted with 0.001 mole/liter potassium chloride. The temperature of the measurements was 20° C. The Z-average values are reported.

Incorporation of monomers having —SO₂F groups was measured using two methods:

1) Fourier Transform Infrared Spectrometer available under the trade designation “NICOLET OMNIC 5.1” from Thermo Electron Corporation, Waltham, Mass. The measurements were done using transmission technique on hot-pressed films (100-200 micrometers thickness). The MV4S-content in mole percent was determined (in Absorbance mode) as the peak height at 1004 cm⁻¹ divided by the peak height at 2365 cm⁻¹ multiplied by 0.0632.

2) ¹⁹F-NMR using a nuclear magnetic resonance spectrometer available from Varian, Inc., Palo Alto, Calif., under the trade designation “INOVA 400 WB” equipped with a 3.2 mm MAS probe.

The degree of hydrolysis of the SO₂F-containing polymer was determined by attenuated total reflectance infrared spectroscopy (ATR IR) using a Fourier Transform Infrared Spectrometer available under the trade designation “NICOLET OMNIC 5.1” from Thermo Electron Corporation. The measurements were made using the ATR technique on hot-pressed films (100-200 micrometers thickness). The degree of hydrolysis in percent was determined by measuring the baseline corrected peak height at 1050-1080 cm⁻¹ and dividing by the baseline corrected peak height at 1450-1475 cm⁻¹.

### Preparation of F₂C═CFO(CF₂)₄SO₂F (MV4S)

The preparation of F₂C═CFO(CF₂)₄SO₂F is described in U.S. Pat. No. 6,624,328 (Guerra), the disclosure of which is incorporated herein by reference.

Preparation of Fluorinated Hydrolyzable Polymer Dispersion (Dispersion A)

390 g of MV4S was pre-emulsified into 270 g of water with the addition of 13.5 g of LiOH.H₂O over 5 minutes under high shear conditions (24,000 rpm, using a mixer available under the trade designation “ULTRA-TURRAX MODEL T 25 DISPERSER” available from IKA-Werke GmbH & Co. KG, Staufen, Germany). The resultant milky white dispersion had an average particle size of 1.5 micrometers and a shelf life of >3 hours. A 53-liter polymerization kettle equipped with an impeller agitator system was charged with 23 kg of deionized water. The kettle was heated at 60° C., and then the pre-emulsion was charged into the oxygen-free polymerization kettle. At 60° C. the kettle was further charged with 630 g of gaseous tetrafluoroethylene (TFE) to 6 bars (600 kPa) absolute reaction pressure. At 60° C. and 240 rpm agitator speed the polymerization was initiated by addition of 15 g of sodium disulfite and 40 g of ammonium peroxodisulfate. During the course of the reaction, the reaction temperature was maintained at 60° C. Reaction pressure was maintained at 6 bars (600 kPa) absolute reaction pressure by feeding additional TFE into the gas phase.

A second portion of MV4S-pre-emulsion was prepared in the same manner and proportions described above, but using 4,600 g of MV4S, 160 g of LiOH.H₂O and 3,200 g of water. The second pre-emulsion portion was fed into the liquid phase during the course of the reaction continuously. After feeding 6,150 g of TFE in 252 minutes polymerization time, the monomer valve was closed and the monomer feed interrupted. The continuing polymerization reduced the pressure of the monomer gas phase to 2 bars (200 kPa) within 40 minutes. At that time, the reactor was vented and flushed with nitrogen gas. The 38.4 kg of polymer dispersion thus obtained had a solids content of 29.2 percent and a pH of 3. The average particle size of the latex was 139 nanometers, as measured using dynamic light scattering. The freeze-coagulated polymer was pressed into 100 to 200 micrometers thick films at 300° C. Infrared spectroscopic measurements on the polymer films showed an incorporation of 14.1 mole percent of MV4S. The melt flow index of the polymer films at 265° C. and 5 kg was 0.3 g/10 minutes.

Preparation of Fluorinated Hydrolyzable Polymer Dispersion (Dispersion B)

900 g of MV4S was pre-emulsified into 560 g of water with the addition of 16 g of a 30 percent by weight perfluorooctanoate ammonium salt solution (available under the trade designation “3M FLUORAD FX1006” from 3M Company, St. Paul, Minn.) over 10 minutes under high shear conditions (24,000 rpm, using a mixer available under the trade designation “ULTRA-TURRAX MODEL T 25 DISPERSER” available from IKA-Werke GmbH & Co. KG, Staufen, Germany). The particle size of the dispersion was approximately 1500 nanometers. A 53-liter polymerization kettle equipped with an impeller agitator system was charged with 37 g of ammonium oxalate monohydrate and 7 g of oxalic acid dihydrate in 22.9 kg of deionized water and 269 g of 30 percent by weight perfluorooctanoate ammonium salt solution (available under the trade designation “3M FLUORAD FX1006” from 3M Company). The oxygen-free kettle was then heated to 50° C. and the agitation system was set to 240 rpm. After the kettle was purged with tetrafluoroethylene (TFE), the pre-emulsion was then charged into the reaction kettle. The kettle was further charged with 705 g of gaseous tetrafluoroethylene (TFE) to 6 bars (600 kPa) absolute reaction pressure. Polymerization was initiated by addition of 140 g of a 1 percent by weight solution of potassium permanganate. During the course of the reaction, the reaction temperature was maintained at 50° C. Reaction pressure was maintained at 6 bars (600 kPa) absolute reaction pressure by feeding additional TFE into the gas phase. A second MV4S-pre-emulsion was prepared in the same manner described above, using 4,170 g of MV4S, 73 g of 30 percent by weight perfluorooctanoate ammonium salt solution (available under the trade designation “3M FLUORAD FX1006” from 3M Company) and 2,500 g of water. The second pre-emulsion was fed into the liquid phase during the course of the reaction. After feeding 5,575 g of TFE in 330 minutes polymerization time, the monomer valve was closed and the monomer feed interrupted. The continuing reaction reduced the pressure of the monomer gas phase to 3.4 bar (340 kPa) within 40 minutes. At that time, the reactor was vented and flushed with nitrogen gas. The 37.1 kg of polymer dispersion thus obtained had a solids content of 27.5 percent by weight and a pH of 3. The dispersion consisted of latex particles having a diameter of 70 nanometers. The polymer was freeze-coagulated, washed with demineralized water in four cycles and was dried for 15 hours at 130° C. Solid state ¹⁹F-NMR spectroscopic analysis indicated that the polymer contained 85.3 mole percent TFE and 14.7 mole percent MV4S. The peak height ratio of the —SO₃⁻ absorbance to the —SO₂F absorbance for the polymer was 0.007 (measured as a hot pressed film), and the melt flow index at 265° C. and 2.16 kg was 0.2 g/10 min.

Hydrolysis of Fluorinated Hydrolyzable Polymer Dispersions

Dispersion A (1000 g) was hydrolyzed with stirring using 31 g of lithium hydroxide monohydrate at 80° C. for 4 hours. The resultant dispersion of ionic fluoropolymer, which had no discernible —SO₂F as measured by ATR IR, was diluted with deionized water to a concentration of 5 percent by weight (Dispersion AH). The ion content of Dispersion AH was: Li⁺=4000 parts per million (ppm); NH₄⁺=150 ppm; Na⁺=100 ppm; F⁻=5000 ppm; SO₄²⁻=800 ppm; SO₃²⁻=300 ppm; MV₄SO₃⁻=17000 ppm.

Dispersion B was cation-exchanged to remove Mn²⁺ ions that could form MnO₂ during the hydrolysis, and then hydrolyzed in the same manner as Dispersion A. Cation-exchange was carried out according to the Purification of Dispersion of ionic fluoropolymer (Method 2) procedure below, wherein 20 g of cationic exchange resin (trade designation “DOWEX 650C”) was used per 1000 g of Dispersion B. The resultant dispersion of ionic fluoropolymer, which had no discernible —SO₂F as measured by ATR IR, was diluted with deionized water to a concentration of 5 percent by weight (Dispersion BH). The ion content of Dispersion BH was: Li⁺=6000 ppm; NH₄⁺=350 ppm; K⁺=100 ppm; Mn⁺=40 ppm; F⁻=6300 ppm; C₂O₄²⁻=600 ppm; PFOA⁻=3000 ppm; MV₄SO₃⁻=14000 ppm.

Purification of Dispersion of Ionic Fluoropolymer (Method 1)

Aliquots of Dispersion AH and Dispersion BH were individually cation-exchanged using a 400-mL column filled with 315 g of cation-exchange resin (available under the trade designation “DOWEX 650C” from Dow Chemical, Midland, Mich.) at a rate of one bed volume per hour. After 13 hours, this procedure was finished and analysis by Flame Atomic Absorption Spectrometry showed the level of metal cations and ammonium ions was below 1 part per million.

The cation-exchanged dispersions were then each anion-exchanged using a 400-mL column filled with 250 g of anion-exchange resin (available under the trade designation “AMBERLYST A260H” from Rohm and Haas Company, Philadelphia, Pa.) at a rate of one bed volume per hour. This process took 13 hours. Analysis (MV4SO₃⁻ content was determined using high performance liquid chromatography; F⁻ content was determined using ion selective electrode, C₇F₁₅COO⁻: was determined by gas chromatography) showed less than 50 parts per million of low molecular weight anionic species with molecular weight below 2,000 g/mole in the purified dispersions. Dispersion AH purified as above is denoted Dispersion AHP1. Dispersion BH purified as above is denoted Dispersion BHP1.

Purification of Dispersion of Ionic Fluoropolymer (Method 2)

Aliquots of Dispersion AH and Dispersion BH were individually cation-exchanged using 612 g of cation-exchange resin (available under the trade designation “DOWEX 650C” from Dow Chemical) stirred in a 2-L round bottom flask with heating at a temperature of from 40° C. to 50° C. After 5 hours, this procedure was finished and analysis by Flame Atomic Absorption Spectrometry showed the level of metal cations and ammonium ions was below 1 part per million.

The cation-exchanged dispersions were then each anion-exchanged using a 430 g of anion-exchange resin (available under the trade designation “AMBERLYST A260H” from Rohm and Haas Company) stirred in a 2-L round bottom flask at elevated temperatures for 2 hours. Analysis (MV4SO₃⁻ content was determined using high performance liquid chromatography (HPLC); F⁻ content was determined using an ion selective electrode; perfluorooctanoate (PFOA⁻) was determined by gas chromatography) showed less than 50 parts per million of low molecular weight anionic species with molecular weight below 2000 g/mole in the purified dispersions. Dispersion AH purified as above is denoted Dispersion AHP2. Dispersion BH purified as above is denoted Dispersion BHP2.

Concentration of Ion Exchanged Dispersions and Dilution with n-Propanol

The purified dispersion of ionic fluoropolymers prepared above (i.e., Dispersions AHP1, BHP1, AHP2, and BHP2) were concentrated to 40 percent solids by weight in a 2-L round bottom flask using a stirrer at 80° C., and at a reduced pressure of 200 mbar (0.2 kPa). The resulting gel (500 g) was combined with 500 g of n-propanol at 65° C. Each of the four purified dispersions had 20 percent by weight polymer solids; 30 percent by weight water (by Karl-Fischer Method); 50 percent by weight n-propanol, pH=2; Li⁺ concentration of less than <1 part per million (ppm) (by Flame Atomic Absorption Spectrometry); PFOA⁻<5 ppm (by HPLC); F⁻<15 ppm (by ion selective electrode).

Various modifications and alterations of this invention may be made by those skilled in the art without departing from the scope and spirit of this invention, and it should be understood that this invention is not to be unduly limited to the illustrative embodiments set forth herein.

1. A method of making a dispersion of ionic fluoropolymer comprising:
providing a dispersion of a hydrolyzable fluoropolymer in a first aqueous medium by emulsion polymerization, the hydrolyzable fluoropolymer having a plurality of pendant hydrolyzable groups represented by the formula —R¹SO₂X, wherein R¹ is a perfluoroalkylene group having from 1 to 15 carbon atoms, or a perfluoroalkyleneoxy or perfluoropoly (alkylencoxy) group having from 1 to 15 carbon atoms and from 1 to 4 oxygen atoms, and X represents F, Cl, or Br;
combining a base with the dispersion to form a reaction mixture; and
maintaining the reaction mixture at sufficient temperature and for sufficient time to cause at least a majority of the hydrolyzable groups to hydrolyze and form a dispersion of ionic fluoropolymer in a second aqueous medium, wherein the ionic fluoropolymer has a sulfonate equivalent weight in the range of from at least 600 grams up to and including 1200 grams.

2. The method of claim 1, and wherein the first and second aqueous mediums are the same.

3. The method of claim 1, wherein R¹ represents —OCF₂CF₂CF₂CF₂— or —OCF₂CF(CF₃)OCF₂CF₂—.

4. The method of claim 1, wherein R¹ represents —OCF₂CF₂CF₂CF₂—.

5. The method of claim 1, wherein the temperature is at least 60 degrees Celsius.

6. The method of claim 1, wherein the base is selected from the group consisting of an alkali metal hydroxide, ammonium hydroxide, an alkali metal carbonate, or a combination thereof.

7. The method of claim 1, wherein the base comprises lithium hydroxide or ammonium hydroxide.

8. The method of claim 1, wherein the base comprises lithium hydroxide.

9. The method of claim 1, wherein the fluoropolymer is preparable from monomers comprising at least
F₂C═CF—R¹—SO₂X
wherein R¹ is a perfluoroalkylene group having from 1 to 15 carbon atoms, or a perfluoroalkyleneoxy or perfluoropoly (alkyleneoxy) group having from 1 to 15 carbon atoms and from 1 to 4 oxygen atoms, and X represents F, Cl, or Br; and
F₂C═CFR², wherein R² represents F or a branched or unbranched perfluoroalkyl, perfluoroalkoxy or perfluoropoly(alkyleneoxy) group comprising 1-5 carbon atoms and from 0 to 2 oxygen atoms.

10. The method of claim 9, wherein the monomers further comprise at least one of: tetrafluoroethylene; hexafluoropropylene; CF₃OCF₂CF₂CF₂OCF═CF₂; CF₃OCF═CF₂; CF₃CF₂CF₂OCF═CF₂; a perfluoro-1,3-dioxole; a perfluorinated diolefin; a perfluorinated vinyl ether represented by the formula
F₂C═CFO(R_{f}O)ₙ(R_{f′}O)ₘR_{f″}
wherein R_{f} and R_{f′} are different linear or branched perfluoroalkylene groups having 2 to 6 carbon atoms, m and n are independently integers of from 0 to 10 and the sum of n and m is at least 1, and R_{f″} is a perfluoroalkyl group having 1 to 6 carbon atoms; a perfluorinated vinyl ether monomer represented by the formula
F₂C═CFO[(CF₂CF(CF₃)O)ᵢ(CF₂CF₂CF₂O)ⱼ(CF₂)ₖ]CₓF₂ₓ₊₁
wherein i and j are independently integers in the range of from 0 to 10, k is an integer in the range of from 0 to 3, and x is an integer in the range of from 1 to 5; and a perfluorinated vinyl ether represented by the formula
F₂C═CFOCF₂CF(CF₃)O(CF₂O)_{q}CF₃
q is an integer in the range of from 0 to 3.

11. The method of claim 9, wherein the monomers further comprise at least one of ethylene, propylene, butylene, trifluoroethylene, 1-hydropentafluoropropene, 2-hydropentafluoropropene, vinyl fluoride, or vinylidene difluoride.

12. The method of claim 1, wherein the temperature is in the range of from at least 60 up to and including 80 degrees Celsius.

13. The method of claim 1, wherein the dispersion of ionic fluoropolymer further comprises organic solvent selected from the group consisting of methanol, ethanol, isopropanol, n-propanol, ethylene glycol, propylene glycol, glycerol, tetrahydrofuran, dioxane, acetonitrile, acetone, and combinations thereof.

14. The method of claim 1, wherein the hydrolyzable fluoropolymer has a fluorine content of at least 50 percent by weight based on the total weight of the polymer.

15. The method of claim 1, wherein the hydrolyzable fluoropolymer has a fluorine content or at least 70 percent by weight based on the total weight of the polymer.

16. The method of claim 1, further comprising at least partially removing water from the dispersion of ionic fluoropolymer, and adding organic solvent to the dispersion of ionic fluoropolymer to provide a solvent exchanged dispersion.

17. The method of claim 1, further comprising combining catalyst and carbon particles with the dispersion of ionic fluoropolymer.

18. The method of claim 1, further comprising forming an ionic fluoropolymer membrane from the dispersion of ionic fluoropolymer.

19. The method of claim 18, further comprising incorporating the ionic fluoropolymer membrane into a membrane electrode assembly.

20. The method of claim 1, further comprising removing at least a portion of cationic impurities from the dispersion of ionic fluoropolymer using a cation-exchange resin to provide a cation-exchanged dispersion of ionic fluoropolymer.

21. The method of claim 20, further comprising combining catalyst and carbon particles with the cation-exchanged dispersion of ionic fluoropolymer.

22. The method of claim 20, further comprising forming an ionic fluoropolymer membrane from the cation-exchanged dispersion of ionic fluoropolymer.

23. The method of claim 22, further comprising incorporating the ionic fluoropolymer membrane into a membrane electrode assembly.

24. The method of claim 1, further comprising removing at least a portion of anionic impurities from the dispersion of ionic fluoropolymer using an anion-exchange resin to provide an anion-exchanged dispersion of ionic fluoropolymer.

25. The method of claim 24, further comprising combining catalyst and carbon particles with the anion-exchanged dispersion of ionic fluoropolymer.

26. The method of claim 24, further comprising forming an ionic fluoropolymer membrane from the anion-exchanged dispersion of ionic fluoropolymer.

27. The method of claim 26, further comprising incorporating the ionic fluoropolymer membrane into a membrane electrode assembly.

28. The method of claim 24, further comprising removing at least a portion of cationic impurities from the anion-exchanged dispersion of ionic fluoropolymer using a cation-exchange resin to provide a cation-exchanged dispersion of ionic fluoropolymer.

29. The method of claim 28, further comprising combining catalyst and carbon particles with the cation-exchanged dispersion of ionic fluoropolymer.

30. The method of claim 28, further comprising forming an ionic fluoropolymer membrane from the cation-exchanged dispersion of ionic fluoropolymer.

31. The method of claim 30, further comprising incorporating the ionic fluoropolymer membrane into a membrane electrode assembly.
